(19) United States
(12) Patent Application Publication
(10) Pub. No.: US 2015/0330846 A1
(43) Pub. Date: Nov. 19, 2015

(54) MOUNTING METHOD FOR A STRAIN GAGE

(71) Applicant: THIELE GMBH & CO. KG, Iserlohn (DE)

(72) Inventor: Bernhard NORPOTH, Essen (DE)

(73) Assignee: THIELE GMBH & CO. KG, Iserlohn (DE)

(21) Appl. No.: 14/654,385

(22) PCT Filed: Nov. 14, 2013
(86) PCT No.: PCT/DE2013/000681

§ 371 Date: Jun. 19, 2015

(30) Foreign Application Priority Data
Dec. 21, 2012 (DE) 10 2012 112 947.9

(51) Int. Cl. G01L 1/00; C09J 5/00

(52) U.S. Cl. CPC G01L 1/00; C09J 5/00

(57) ABSTRACT

A method of adhesively bonding a strain gauge in an opening having the steps of providing a component, cleaning the inner lateral surface of the opening, providing an insert, wherein the insert has an outer lateral surface which corresponds essentially to the inner lateral surface of the opening and, on its outer lateral surface, has a mount for the strain gauge, wherein the strain gauge is positioned in the mount, introducing an adhesive into the opening and/or applying an adhesive to the strain gauge, positioning the insert in the opening, wherein the strain gauge is moved into the vicinity of that region of the inner lateral surface on which it is to be fastened.

### RELATED APPLICATIONS

The present application is a National Phase of International Application Number PCT/DE2013/000681, filed Nov. 14, 2013, and claims priority from German Application Number DE 10 2012 112 947.9, filed Dec. 21, 2012.

The present invention relates to a method of adhesively bonding a strain gauge in an opening according to the features in the preamble of patent claim 1.

Mechanical components, in particular steel components, are subjected to intensive stressing, and resulting wear, during use. In particular the abrasive wear on surfaces can already be ascertained from time to time by visual inspection when non-destructive material testing is carried out.

The mechanical stressing which is present in the component itself, however, cannot be ascertained directly from the outside. There are likewise non-destructive material-testing methods for this purpose, but these, for example in the event of X-ray or of ultrasound being used, require fairly complex measuring technology and, furthermore, can be carried out only when the appropriate machines or parts are at a standstill.

The prior art therefore discloses, for example in DE 102 34 626 A1, the practice of introducing into mechanical components sensors which can monitor internal stressing of the component itself even during operation. Sensors which are introduced correspondingly into the components are usually strain gauges which are known from the prior art and which make it possible to detect mechanical expansion and convert this into electrical signals.

Proceeding from the prior art, it is an object of the present invention to present a method which makes it possible for strain gauges to be arranged correctly, with a high level of reproducibility, in complex installation situations, in particular on the inner lateral surface of openings or bores.

The aforementioned object is achieved according to the invention by a method according to the features in patent claim 1.

Advantageous variants form the subject matter of the dependent patent claims.

The method according to the invention of adhesively bonding a strain gauge in an opening of a component, in particular in a bore in a metallic component, is characterized by the following method steps:
providing the component,
cleaning the inner lateral surface of the opening,
providing an insert, wherein the insert has an outer lateral surface which corresponds essentially to the inner lateral surface of the opening and, on its outer lateral surface, has a mount for the strain gauge, wherein the strain gauge is positioned in the mount,
introducing an adhesive into the opening and/or applying an adhesive to the strain gauge,
positioning the insert in the opening, wherein the strain gauge is moved into the vicinity of that region of the inner lateral surface on which it is to be fastened,
inserting a wedged pin into a guide of the insert, wherein the wedged pin engages beneath the strain gauge, on the underside thereof, and raises it up in relation to the insert and presses it onto the inner lateral surface,
at least partially curing the adhesive and optionally removing the wedged pin and/or insert from the opening.

First of all, an appropriate component, in particular a steel chain, for example a plate link chain or else also a round steel chain or a similar chain is provided. The region which is to be monitored, or else the chain component which is to be monitored, is then provided with an opening in the form of a bore, wherein the bore, in the first instance, is pretreated such that chemical and/or physical cleaning takes place. As a result, the inner lateral surface of the bore is prepared optimally for the following adhesive-bonding operation of the strain gauge.

The invention then provides an insert which has a geometrical outer contour corresponding essentially to the inner contour of the opening, in particular of the bore. A clearance fit is preferably formed here between the insert and the opening, and therefore a minimal gap always remains between the outer lateral surface of the insert and inner lateral surface of the opening. This ensures that the insert can be inserted particularly smoothly in the first instance into the opening.

The insert itself has a mount, in particular in the form of a recess on the outer lateral surface, in order to accommodate the strain gauge. The strain gauge is then positioned in the mount of the insert and an adhesive is applied to the strain gauge and/or an adhesive is introduced into the inner lateral surface of the opening. Thereafter, the insert, with the strain gauge, is pushed into the opening and can be positioned by rotation such that the strain gauge is positioned on a preliminary basis at the desired location of the inner lateral surface.

The insert itself has a guide, in particular in the form of a guide slot, wherein the guide slot is arranged beneath the strain gauge, as seen in relation to the radial direction. A wedged pin is then introduced into the guide slot itself, wherein the wedged pin on its inner side, as seen in relation to the radial direction, ends up butting against the insert and, on the opposite side, engages beneath the strain gauge. On account of the wedge shape, in particular of the wedge tip, the wedged pin then raises the strain gauge and pushes or presses it onto the inner lateral surface of the opening, as seen in relation to the radial direction. The strain gauge is thus pressed homogeneously, over its entire surface area, against the inner lateral surface, wherein the strain gauge itself is positioned precisely, once again in relation to the radial direction and axial direction of the opening. This ensures that, on the one hand, the strain gauge is introduced into the opening itself and, on the other hand, the measured values supplied by the strain gauge on account of the quality of installation, are highly reliable and do not depend on the manual dexterity of the person who fits the strain gauge.

Once the adhesive has at least partially cured, it is then possible to remove at least the wedged pin and, as an optional addition, also to remove the insert itself from the opening again. It is possible for appropriate connection lines for the strain gauge to be guided, for example, through the guide slot of the removed wedged pin or else to be already present on the strain gauge and, routed out of the insert through cable openings or cable ducts, to be guided to a measuring sensor.

In particular, the method according to the invention is suitable for adhesively bonding strain gauges in a bore, wherein the bore has a diameter ranging from 5 mm to 100 mm, preferably from 8 mm to 80 mm, quite particularly preferably from 10 mm to 50 mm. It is not possible here, from time to time, for a fitter to use, for example, a finger to reach into the bore himself. However, the auxiliary tools according to the invention for adhesively bonding the strain gauge can ensure correct mounting of the strain gauge even in such an installation position. The method is thus also suitable for automating the operation of introducing a strain gauge into an appropriate bore and, at the same time, increases the accuracy of the results measured by the strain gauge introduced into the opening by the method according to the invention.

Furthermore, it is particularly preferred for the strain gauge nevertheless to be applied first of all to a carrier, in particular the strain gauge being adhesively bonded to the carrier itself, wherein the carrier has a curvature which corresponds essentially to the curvature of the inner lateral surface of the opening. The carrier makes it possible to position the strain gauge in the insert and, at the same time, avoids damage to the strain gauge as a result of the wedged pin on its underside during the raising operation. The contact-pressure forces applied by the wedged pin, in addition, are distributed over the surface area by the carrier, and this also means that the strain gauge does not experience any damage as a result of being subjected to contact pressure by the wedged pin. The carrier preferably has a curvature which corresponds to the inner lateral surface of the opening.

It is preferably the case here that the insert itself, the wedged pin and/or the carrier are formed from a plastics material, in particular from an injection-molded plastics material. However, within the framework of the invention, the wedged pin is preferably formed from a metallic material, in particular from a steel material, and therefore said wedged pin is not itself compressible during the contact-pressure operation; rather, correspondingly, the compressive force produced by the operation of the wedged pin being pushed in is also transmitted, by the wedged pin, to the carrier and thus to the strain gauge which is to be adhesively bonded.

Furthermore, a clearance fit is preferably formed between the insert and the opening itself. The insert is preferably round in cross section and introduced into a bore. The insert itself then has, on its outer lateral surface, protuberances which project in relation to said outer lateral surface and center the insert in the opening itself. In the case where the insert is formed from a plastics material, the protuberances can taper to a point such that, during the pushing-in operation, they are easily compressed and/or deformed and, accordingly, center the insert in the opening. It is also possible for the insert itself to have further centering contours, in order to assist correct positioning. These centering contours can center the insert in the bore in particular in the radial direction, but also in the axial direction. In particular, a centering contour is formed in the axial direction in the form of a stop, and this means that the insert can be pushed into the bore only up to a certain extent in the axial direction. This avoids the situation where the insert is pushed through the bore or else is pushed accidentally too far into the bore. This, in turn, increases the precision of the positioning of the strain gauge within the bore in particular in the axial direction.

The insert and the carrier are preferably, as already described above, formed from a plastics material. These may be produced as separate components. However, it is optionally also possible, within the framework of the invention, for the insert and the carrier to be formed in one piece and from the same material, wherein a coupling is present between the carrier and the insert. The coupling itself may be, for example, in the form of crosspieces or connecting pins which then, upon insertion of the wedged pin into the guide, are expanded or else break or rupture, and therefore the carrier is pushed radially outward onto the inner lateral surface of the bore.

The method according to the invention is also suitable for mounting two, three or even more strain gauges at the same time, in a radially distributed manner, in the bore. The plurality of strain gauges are then distributed over the outer lateral surface of the insert and inserted, with the insert, into the bore. A central wedged pin and corresponding force transmission then make it possible to press the strain gauges against the inner lateral surface of the bore, and wait for curing to take place. The strain gauge is then connected, in turn, via electrical connection lines, to an evaluation unit or else also, for example, to a radio transmitter and/or an energy source. It is possible for the connection lines already to be fastened directly on the strain gauge and to be routed out of the bore via an aperture or recess on the insert. It is also possible however, within the framework of the invention, for the wedged pin to be removed once the adhesive has cured, and for the connection lines to be guided to the strain gauge through the guide which remains. It is also possible, within the framework of the invention, for the insert itself to be able to serve as a carrier for control electronics and/or for evaluation electronics. It is also possible for a radio transmitter or else some other wireless transmitter to be accommodated in the insert itself, and therefore the data picked up via the strain gauge can be transmitted from here to an evaluation unit by means of wireless transmission. Within the framework of the invention, it is also possible for the insert itself to be designed in the form of a mount and/or housing, for example for a storage battery, in particular a battery which supplies the control electronics and/or evaluation electronics and the wireless-data-transmission means with power.

It is further possible for the insert to have at least one encircling seal, the bore therefore being sealed by the insert itself. This avoids the situation where moisture and/or dirt, in particular corrosive moisture, passes into the bore and falsifies the measurements obtained using the strain gauge, or even damages the strain gauge. It is also possible however, within the framework of the invention, to design the insert such that it has accommodating points, for example in the form of plug-in holes, in order for an appropriate cover to be positioned on the insert, wherein the cover, in turn, closes the bore or opening in its entirety, in particular in a fluid-tight manner. In these last cases, the insert would then also remain fitted in the bore during operation.

Further advantages, features, properties and aspects of the present invention form a constituent part of the following description. Preferred variants are illustrated in the schematic figures. In these figures, which serve to give a simple understanding of the invention:

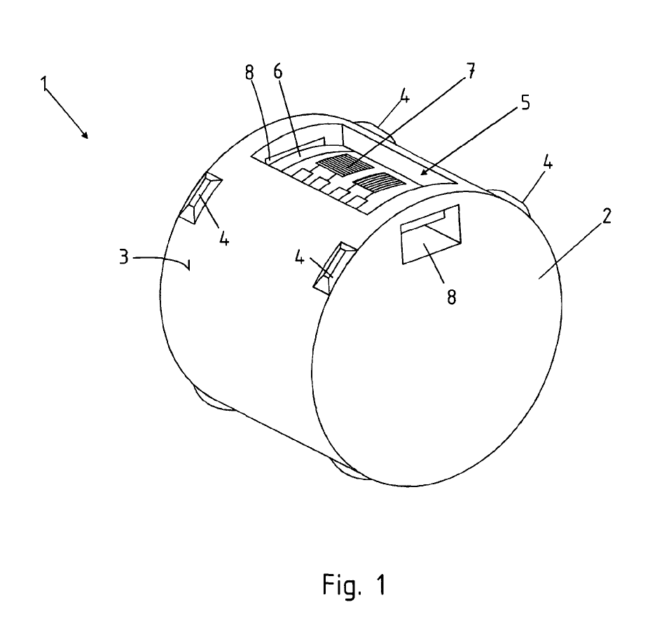

FIG. 1 shows an insert according to the invention with the strain gauge on a carrier;

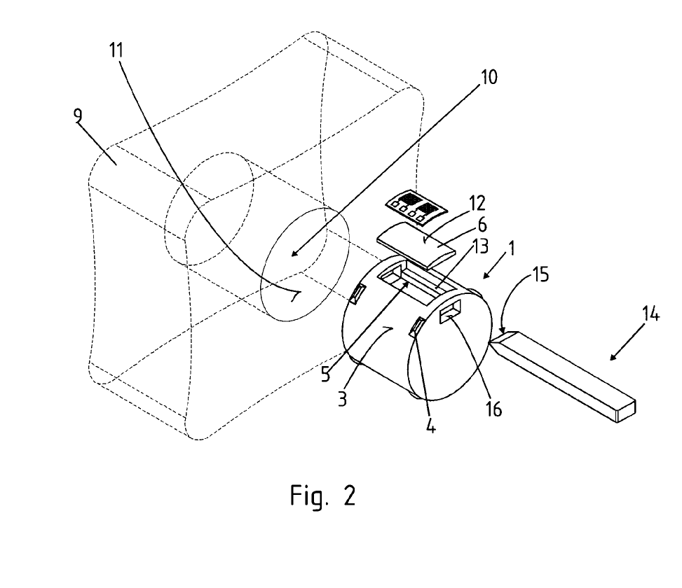

FIG. 2 shows an exploded illustration of a structural element with the insert, carrier, strain gauge and wedged pin arranged in front of it;

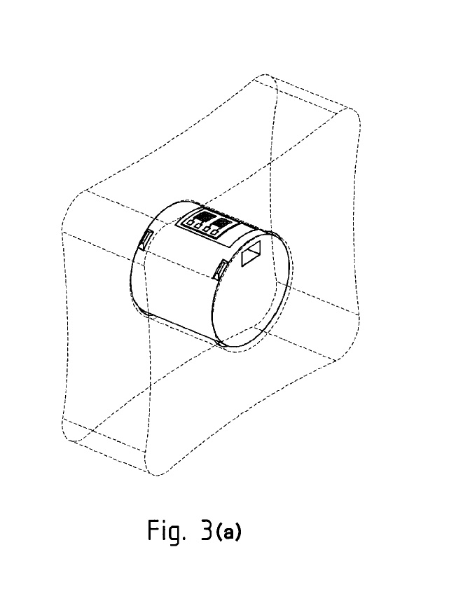

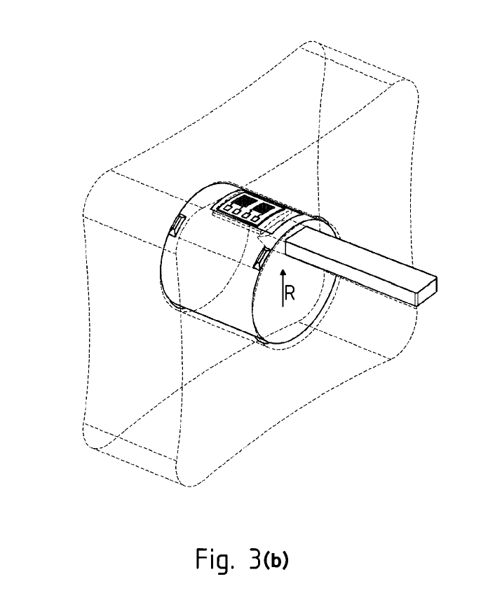

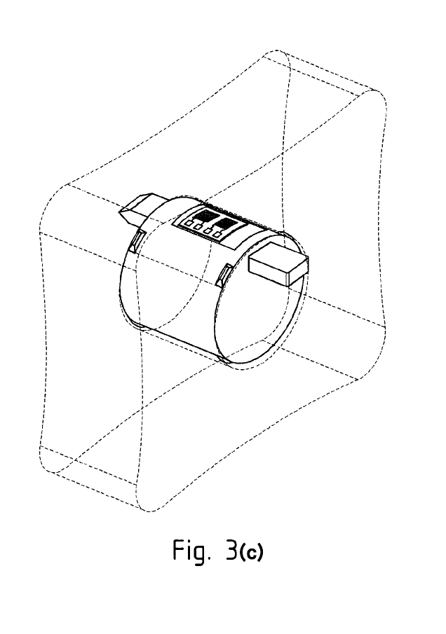

FIGS. 3a show the individual steps of the method according to the invention to 3c being implemented; and

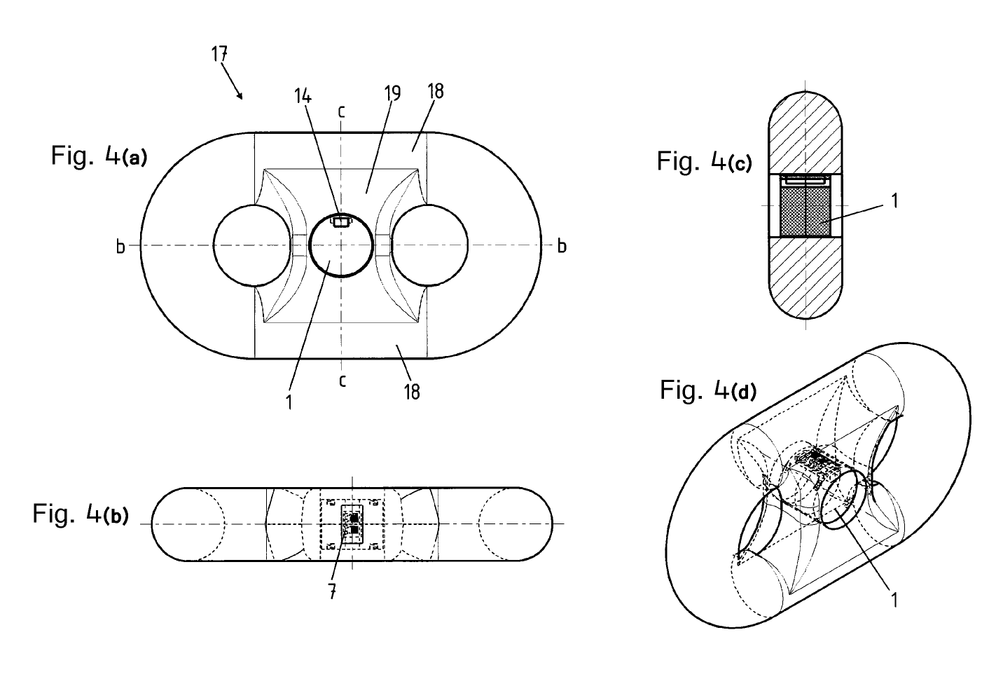

FIGS. 4a show a possible installation situation of a strain gauge, with insert, in to 4d a crosspiece of a chain link.

In the figures, the same or like components are designated by the same reference signs, even if a repeated description of said components is dispensed with for reasons of simplicity.

FIG. 1 shows an insert 1 according to the invention which is used as an auxiliary tool for the method according to the invention. The insert 1 itself is designed in the form of a cylindrical body 2, wherein protuberances 4 project in relation to an outer lateral surface 3 and center the insert 1 in a corresponding bore 10 or opening. A mount 5 is formed in the outer lateral surface 3 of the insert 1 itself, the mount 5 being in the form of a depression. In this mount 5, a carrier 6, with a strain gauge 7 adhesively bonded thereon, is arranged such that it is recessed in relation to the outer lateral surface 3. The mount 5 itself, in turn, has two insertion openings 8, through which a wedged pin (not illustrated at this stage) can be inserted.

FIG. 2 shows the exploded illustration of the component 9 with an opening in the form of a bore 10. The bore 10 here has an inner lateral surface 11, which corresponds essentially to the outer lateral surface 3 of the insert 1. In this case, the protuberances 4, which project in relation to the outer lateral surface 3, butt against the inner lateral surface 11 of the component 9 and center the insert 1 in the bore 10, which is illustrated in FIG. 3a. The carrier 6 itself has, on its surface, a curvature 12 which corresponds essentially also to the curvature of the inner lateral surface 11 of the bore 10.

The strain gauge 7 is positioned on, and/or adhesively bonded to, the curvature 12. The carrier 6 itself then rests on supports 13 in the mount 5 in the insert 1. By virtue of the wedged pin 14 being inserted through the insertion opening 8, as illustrated in FIG. 3b, the carrier 6, together with the strain gauge 7, is raised in the radial direction R and pushed onto the inner lateral surface 11 of the bore 10. The wedged pin 14 itself has, for this purpose, a wedge tip 15 and, as illustrated in FIG. 3c, can also be guided, for example, all the way through the insert 1. The wedged pin 14 then rests on a lower surface 16 or the support 13 in the mount 5 and pushes the strain gauge 7 onto the inner lateral surface 11 of the bore, and therefore an adhesive (not illustrated specifically) ensures that the strain gauge 7 is adhesively bonded to the inner lateral surface 11.

FIGS. 4a to d show different views of a chain link 17, wherein the chain link 17 itself has two sidepieces 18 and a crosspiece 19, which extends between the sidepieces 18. The insert 1, with wedged pin 14 and strain gauge 7, is introduced into the crosspiece 19 by the method according to the invention.

1. A method of adhesively bonding a strain gauge in an opening of a component, in particular in a bore in a metallic component, characterized by the following method steps:
providing the component,
cleaning the inner lateral surface of the opening,
providing an insert, wherein the insert has an outer lateral surface which corresponds essentially to the inner lateral surface of the opening and, on its outer lateral surface, has a mount for the strain gauge, wherein the strain gauge is positioned in the mount,
introducing an adhesive into the opening and/or applying an adhesive to the strain gauge,
positioning the insert in the opening, wherein the strain gauge is moved into the vicinity of that region of the inner lateral surface on which it is to be fastened,
inserting a wedged pin into an insertion opening of a guide of the insert, wherein the wedged pin engages beneath the strain gauge, on the underside thereof, and raises it up in relation to the insert and presses it onto the inner lateral surface,
at least partially curing the adhesive and optionally removing the wedged pin and/or insert from the opening.

2. The method as claimed in claim 1, wherein the strain gauge is adhesively bonded in a bore, wherein the bore has a diameter between 10 and 50 mm.

3. The method as claimed in claim 1, wherein the strain gauge is applied, in particular adhesively bonded, to a carrier, wherein the carrier has a curvature which corresponds essentially to the curvature of the inner lateral surface of the opening.

4. The method as claimed in claim 1, wherein an insert and/or wedged pin and/or carrier are/is formed from plastics material, in particular from injection-molded plastics material.

5. The method as claimed in claim 1, wherein a clearance fit is formed between the insert and the opening, wherein the insert preferably has protuberances, which project in relation to the outer lateral surface of the insert and center the insert in the opening.

6. The method as claimed in claim 1, wherein the insert and the carrier are formed in one piece and from the same material, wherein a coupling is formed between the insert and carrier such that, upon insertion of the wedged pin, the coupling can be expanded or the coupling breaks or ruptures.

7. The method as claimed in claim 1, wherein the strain gauge is mounted in a bore in a steel chain.

8. The method as claimed in claim 1, wherein a plurality of strain gauges are mounted at the same time using one insert, in particular by way of a central wedged pin.

9. The method as claimed in claim 1, wherein that connection lines for the strain gauge are positioned through the guide once the wedged pin has been removed.
